(19) United States
(12) Patent Application Publication
(10) Pub. No.: US 2009/0167487 A1
(43) Pub. Date: Jul. 2, 2009

(54) SECURE ASSOCIATION BETWEEN DEVICES

(76) Inventors: Rahul C. Shah, San Francisco, CA (US); Mark D. Yarvis, Portland, OR (US)

Correspondence Address: Caven & Aghevli LLC;c/o CPA Global, P.O. BOX 52050, MINNEAPOLIS, MN, 55402, US

(21) Appl. No.: 11/968,077

(22) Filed: Dec. 31, 2007

Related U.S. Application Data
(62) Division of application No. 11/967,149, filed on Dec. 29, 2007.

(51) Int. Cl. G06F 7/04

(52) U.S. Cl. 340/5.2

(57) ABSTRACT

Methods and apparatus relating to secure association between devices are described. In one embodiment, devices capable of communicating via a wireless channel may be authenticated via a different channel established based on observation of the same event by sensors present on the devices. Other embodiments are also disclosed.

### RELATED APPLICATION

The present patent application relates to and claims priority from U.S. patent application Ser. No. 11/967,149, filed Dec. 29, 2007, entitled “Secure Association Between Devices” which is hereby incorporated herein by reference.

### FIELD

The present disclosure generally relates to the field of electronics. More particularly, an embodiment of the invention generally relates to secure association between devices.

### BACKGROUND

Portable computing devices are quickly gaining popularity in part due to their ease of mobility. Secure association of two devices, also known as device pairing, may be an important component of network security for mobile computing devices. Secure association generally involves the secure exchange of cryptographic information between two devices so that they are able to communicate securely over insecure communication channels. For example, some wireless headsets may be securely paired with a phone so that the communication between them is secure.

Some current implementations may allow for exchange of cryptographic keys between two devices over insecure wireless channels such that no eavesdropper may decode the cryptographic information (for example, the Diffie-Hellman protocol). However, the Diffie-Hellman protocol is susceptible to a man-in-the-middle attack in which each of the two devices wishing to pair may instead associate with a third device (i.e., the man in the middle) without realizing it. One approach that may prevent this type of attack uses an out-of-band (OOB) channel to authenticate the devices involved in the Diffie-Hellman exchange with each other. An OOB channel generally refers to a mechanism for sending and/or receiving information to/from another device without using a radio. Often the OOB channel may have the property that it is difficult to tamper with, though it may not necessarily be private. For example, common OOB channels may include Near Field Communications (NFC), or the entry of a password on both devices (which is then verified as being the same on both ends), or the display of a password on one device that needs to be entered on the other device.

One basic requirement of these OOB channels can be that they involve a human to verify whether the two devices that wish to pair are legitimate devices and then use the human to complete the authentication process. So in the case of NFC, for example, a person may have to bring the two devices within NFC communication range (which may be a few centimeters in some current implementations), while in the case of the password entry, the person actually enters the same password on both devices.

One problem with such authentication techniques is that they may require additional hardware such as an NFC reader or tag, or a keyboard and/or display which adds to system cost. Moreover, for very small devices, it may not even be feasible to have keyboards and displays present on the device due to size constraints.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 3 illustrate block diagrams of secure device association systems, according to some embodiments.

FIGS. 2 and 4 illustrate flow diagrams of methods according to some embodiments.

FIGS. 5 and 6 illustrate block diagram of embodiments of computing systems, which may be utilized to implement some embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Some of the embodiments discussed herein may provide techniques for secure association of devices. In an embodiment, devices capable of communicating via a wireless channel may be authenticated via a different channel established by one or more signal generators (such as actuators) and/or sensors (such as accelerometers capable of sensing motion in one or more axis) present on the devices. In one embodiment, the signal generators and/or the sensors may be analog.

In an embodiment, a sensor and signal generator pair (which may be present on two mobile computing devices) may be used as an out of band (OOB) communication channel. For example, a first device (such as a mobile phone) may include a vibration feature (e.g., used as the signal generator) which may be combined with an accelerometer (e.g., used as the sensor) on a second device to form a secure OOB channel between the phone and the second device.

Moreover, techniques discussed herein may be utilized for mobile computing devices applied in various fields, such as healthcare (e.g., for secure exchange of patient information such as for patient monitoring devices at various locations including, for example in a home environment and/or remotely, e.g., via cellular networks, wireless broadband networks, etc.), entertainment, education, telecommunication, mobile computing, etc. Yet another example is in personal medical networks where sensors on a body may send sensed medical data to an aggregation device (such as a computing device, including for example, a PDA (Personal Digital Assistant), mobile phone, MID (Mobile Internet Device), PC (Personal Computer), UMPC (Ultra Mobile PC), or other computing devices such as those discussed herein) using wireless technology.

Furthermore, in an embodiment, a first device may include a first (e.g., analog or digital) sensor to detect an event and logic to generate a first set of data corresponding to the event. A second device may include a second (e.g., digital or analog) sensor to detect the event and logic to generate a second set of data corresponding to the event. Each of the first device and the second device may compare the first set of data and the second set of data to determine whether the first device and the second device are to be securely associated.

FIG. 1 illustrates a block diagram of a secure device association system 100, according to one embodiment. As shown, both devices that are to be associated (e.g., devices 102 and 104) may include a radio (e.g., radios 106 and 108, respectively) that may be for primary communications (e.g., through a wireless communication channel 110, which may or may not be secured, for example, encrypted). Also, a wired channel may be used for primary communications between devices 102 and 104 in some embodiments. Device 102 may also include a signal generator 120 (such as a mechanical actuator, a wireless transducer, etc.) to generate signals that are detected by a sensor 122 (such as an accelerometer capable of sensing motion (e.g., in multiple axis, such as three axis in an embodiment)). More than one signal generator and/or sensor per device may be used in some embodiments.

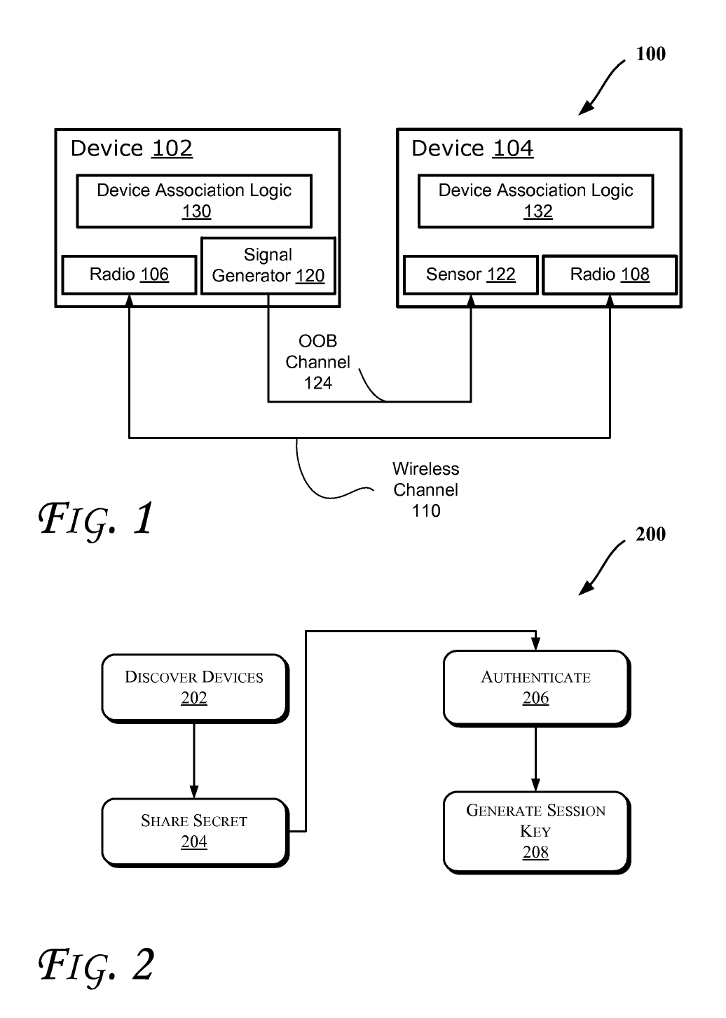

As shown, the signal generator 120 may be coupled to the sensor 122 via an OOB communication channel 124 (e.g., to communicate authentication or secure association signals). Moreover, the OOB communication channel 124 may be a one-way channel in some embodiments, e.g., as demonstrated by the direction of corresponding arrow in FIG. 1. Also, the wireless communication channel 110 may be bidirectional in some embodiments, e.g., as demonstrated by the direction of corresponding arrow in FIG. 1. As is further illustrated in FIG. 1, each of the devices 102 and 104 may also include a device association logic (e.g., logics 130 and 132) to perform various operations, as will be further discussed herein, e.g., with reference to FIG. 2.

In an embodiment, the signal generator 120 may be a vibrator and the sensor 122 may be an accelerometer. Aside from this combination, other possible pairs of signal generators, and sensors could respectively include one or more of: (a) blinking LEDs (Light Emitting Diodes) or a display screen and an image capture device (such as a camera); or (b) speaker and a microphone. Such combinations may provide tamper-free communication without adding a significant extra cost to the system (e.g., since such features may already be present in some mobile devices for other applications). For example, most cell phones and PDAs may have vibrators and cameras built-in. Also, many peripheral devices used for healthcare applications or entertainment may include accelerometers and/or LEDs.

FIG. 2 illustrates a flow diagram of a method 200 to securely associate devices, according to an embodiment. Various components discuss herein, e.g., with reference to FIG. 1 may be utilized to perform one or more of the operations of FIG. 2.

Referring to FIGS. 1 and 2, at an operation 202, two devices that are to be associated (e.g., devices 102 and 104) discover each other and exchange information (e.g., logics 130 and 132 may cause exchange of information via the wireless communication channel 110) about their capabilities so that the association process may be started. At operation 204, a shared secret may be exchanged securely with the other device (e.g., logics 130 and 132 may utilize the Diffie-Hellman algorithm or a similar technique). In an embodiment, the shared secret may be communicated via the wireless communication channel 110.

At an operation 206, one device may authenticate the other device (e.g., device 102 may authenticate device 104 using the OOB communication channel 124). Moreover, at operation 206, the devices (e.g., logics 130 and 132) may verify whether the information exchanged at operation 204 was with the same device in an embodiment. At an operation 208, using the data exchanged at operations 204 and 206, both devices (e.g., logics 130 and 132) may generate identical symmetric encryption keys to encrypt any communication between them from that point onwards (e.g., over the wireless communication channel 110).

During the authentication process (operations 204 and/or 206), information may be transmitted from one device to the other from the signal generator 120 to the sensor 122, and the received information could be used for authentication since the OOB communication channel 124 may be tamper-resistant. In the example of the vibrator-accelerometer combination, the user need only hold the two devices together during the pairing process. The phone may then vibrate with periodic pulses (e.g., where transmission during a period may indicate a “1” and lack of transmission during the time period may indicate a “0” or vice versa), while the peripheral uses its accelerometer to pick up the pulses. By decoding the pulses (e.g., in a manner such as an acoustic modem in an embodiment), the peripheral receives information out of band, which it may use to prove that it is an authentic communication endpoint. Also, analog actuators and sensors may provide an additional mechanism for secure device association, e.g., for smaller devices that do not have a bulkier input device such as a display, keyboard, or touch pad.

In some embodiments, the OOB communication channel 124 may be secure from third-party tampering. Because a person may typically bring the two devices close to each other during the setup process, he/she may verify that no other devices are affecting the pairing process. Also, the sensor and actuator are often already present on the devices (to support existing applications); hence, no additional hardware (or cost) may need to be added to the system. Further, such techniques may easily be integrated into existing secure association methods for wireless devices (such as Bluetooth Core Specification Version 2.1 (Bluetooth SIG, Aug. 1, 2007) or Wi-Fi Protected Setup (Wi-Fi Alliance, Jan. 8, 2007)).

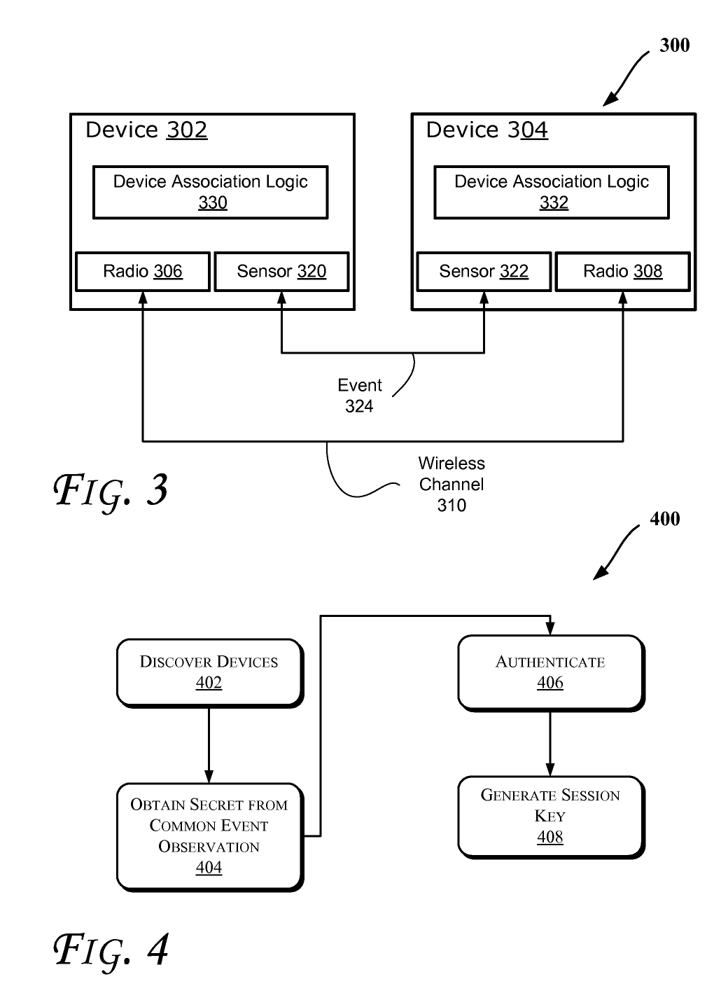

FIG. 3 illustrates a block diagram of a secure device association system 300, according to one embodiment. As shown, both devices that are to be associated (e.g., devices 302 and 304) may include a radio (e.g., radios 306 and 308, respectively) that may be for primary communications (e.g., thorough a wireless communication channel 310, which may or may not be secured, for example, encrypted). A wired channel may be used for primary communications between devices 302 and 304 in some embodiments. As shown, each of the devices 302 and 304 may also include a sensor (e.g., sensors 320 and 322, respectively) to observe an event 324.

In an embodiment, sensors 320 and 322 may be accelerometers that are capable of sensing motion (e.g., in multiple axis, such as three axis in an embodiment). More than one sensor per device may be used in some embodiments. Further, the event 324 may be any event that is detectible by the sensors 320 and 322, such as motion, sound, image, etc. Accordingly, sensors 320 and 322 may be an accelerometer, a microphone, an image capture device (such as a camera), etc.

Moreover, the sensors 320 and 322 may be the same type of (or identical) sensors. As one example, accelerometers may sense an identical event (e.g., event 324) and generate a roughly identical string that may be used for authentication. To generate an identical but random string that may be used for authentication, both devices may be held together in one hand and shaken firmly in a random fashion in one embodiment. Since both devices will sense the same motion, they will have (roughly) identical streams of sensed accelerometer data. Such combinations may provide tamper-free communication without adding a significant extra cost to the system (e.g., since such features may already be present in some mobile devices for other applications). For example, most cell phones and PDAs may have cameras built-in. Also, many peripheral devices used for healthcare applications or entertainment may include accelerometers. Additionally, even though some examples are discussed herein with reference to accelerometers, the OOB communication channel formed by the combination of the sensors and event may also be formed with other types of sensors.

As shown in FIG. 3, each of devices 302 and 304 may also include a device association logic (e.g., logics 330 and 332, respectively). The data sensed by sensors 320 and 322 may then be exchanged between the two devices and logics 330 and 332 may each compare the traces to determine if both devices 302 and 304 witnessed the same event 324, and hence verify the other device. In some embodiments, the aforementioned comparison does not necessarily imply a perfect match. A comparison function implemented by logics 330 and 332 that allows a small number of differences may also be used. Moreover, the two devices may share their sensor streams in a way that enables this comparison to occur securely as will be further discussed herein, e.g., with reference to FIG. 4.

More particularly, FIG. 4 illustrates a flow diagram of a method 400 to securely associate devices, according to an embodiment. Various components discuss herein, e.g., with reference to FIG. 3 may be utilized to perform one or more of the operations of FIG. 4.

Referring to FIGS. 3 and 4, at an operation 402, two devices that are to be associated (e.g., devices 302 and 304) discover each other and exchange information (e.g., logics 330 and 332 may cause exchange of information via the wireless communication channel 310) about their capabilities so that the association process may be started. At operation 404, a shared secret may be generated using sensor data from commonly sensed event 324. For example, logics 330 and 332 may communicate regarding event 324 to determine whether they have detected the same event. In an embodiment, the shared secret may be communicated via the wireless communication channel 310.

At an operation 406, the two devices (e.g., devices 302 and 304) may authenticate each other (e.g., using the information received from the OOB communication channel established based on event 324). Moreover, at operation 406, the devices (e.g., logics 330 and 332) may verify whether the information exchanged at operation 404 was with the same device in an embodiment. At an operation 408, using the data exchanged at operations 404 and 406, both devices (e.g., logics 330 and 332) may generate identical symmetric encryption keys to encrypt any communication between them from that point onwards (e.g., over the wireless communication channel 310).

At operations 406, a protocol may be used by the logics 330 and 332 to allow each device 302 and 304, respectively, to mutually validate that the other device has witnessed the same event via their respective sensors 320 and 322. In an embodiment, the protocol may ensure that neither of the devices reveals their raw sensed stream (or the derived string) to the other device first. Otherwise, the system may be susceptible to a man-in-the-middle attack. This problem may be avoided using a commitment function, e.g., a one way function that allows a device to commit to knowledge of a particular piece of information before that information is revealed. Such techniques may apply equally to both a password and to a string derived from an analog sensor stream. The result of these protocols is that each device will be able to obtain some information from the other, which may be subsequently compared (e.g., by logics 330 and 332) at each device to validate the other. On a given device, if the information matches (as determined by the logics 330 or 332), that device knows that the two devices sensed the same event (e.g., event 324), and hence are authentically the two devices that the user intends to pair.

To enable a system based on analog sensor measurements, comparison between two data streams from analog sensors (e.g., sensors 320 and 322) may be made. This may be accomplished in a number of ways including one or more of:

(a) Statistical techniques: Statistical techniques such as computing the correlation coefficient between the two streams is one way to check the “closeness” of the streams;

(b) Frequency techniques: Computing the frequency spectrum of the time-series data and comparing the resulting spectral data is another way to compare the waveforms;

(c) Looking at coarse data: Comparing strings derived from the sensor data for an exact or a close match; or

(d) Any other method to look at time-series data and check whether they are sufficiently similar

Some techniques to extract coarse data that may be used for comparison include one or more of:

(1) Time between peaks: One approach to compute the time between peaks for two streams, which may be roughly the same for the two streams. Note that the magnitude of the peaks may differ slightly, but the time at which the peaks occur may be nearly identical. A coarse measure of the steam may be created as a string of numbers that represent the time span between adjacent peaks for each stream; or

(2) Sequence of peaks: A second approach is to list the sequence of peaks among multiple parts of the stream. For example, a three dimensional (3D) accelerometer produces x, y and z axes of the data. Peaks among these three streams may occur in some chronological order. For identical data, the peaks should appear in the same order across the two devices in some embodiments. Moreover, any other method may be used to extract coarse data from a sensor stream. This coarse data may allow the identification of the “closeness” of the two data streams and verification of whether the two devices were sensing the same event 324. Once it is established that the two data streams sensed the same event, the two devices are authenticated (e.g., at operation 406) with each other. They may now complete the secure association setup and start secure communications (e.g., at operation 408).

(3) Dominant frequencies: A third approach is to list the dominant frequency components present in each of multiple parts of the stream. For example, a three dimensional (3D) accelerometer produces x, y and z axes of the data. Accelerometer readings in the time domain for each axis may be projected into the frequency domain. The course frequency value of one or more dominant frequency component(s) (those with the largest magnitude peaks in the frequency domain) for one or more of the axes may be composed together to produce a string of numbers.

In some embodiments, it may be necessary to ensure synchronization (in time) between the two nodes. In order for the above algorithms to produce the same or similar result on each of the two nodes, they begin and end sensing at substantially the same time. One embodiment may look for a specific signal characteristic, such as a sharp peak, to identify the starting point. For examples, two nodes with three dimensional (3D) accelerometers may each look for a sharp negative acceleration in the z-axis, indicating that the user has lifted the two devices from a resting position. Since the two devices are held together, they may both see the specific signal characteristic at the same time. The end of sampling may occur a fixed time period after the start, allowing the two nodes to have substantially identical inputs to the above string generation algorithms.

In some embodiments, the OOB communication channel established by detecting event 324 may be secure from third-party tampering. Because a person may typically bring the two devices 302 and 304 close to each other during the setup process, he/she may verify that no other devices are affecting the pairing process. Also, the sensors are often already present on the devices (to support existing applications); hence, no additional hardware (or cost) may need to be added to the system. Further, such techniques may easily be integrated into existing secure association methods for wireless devices (such as Bluetooth Core Specification Version 2.1 (Bluetooth SIG, Aug. 1, 2007) or Wi-Fi Protected Setup (Wi-Fi Alliance, Jan. 8, 2007)).

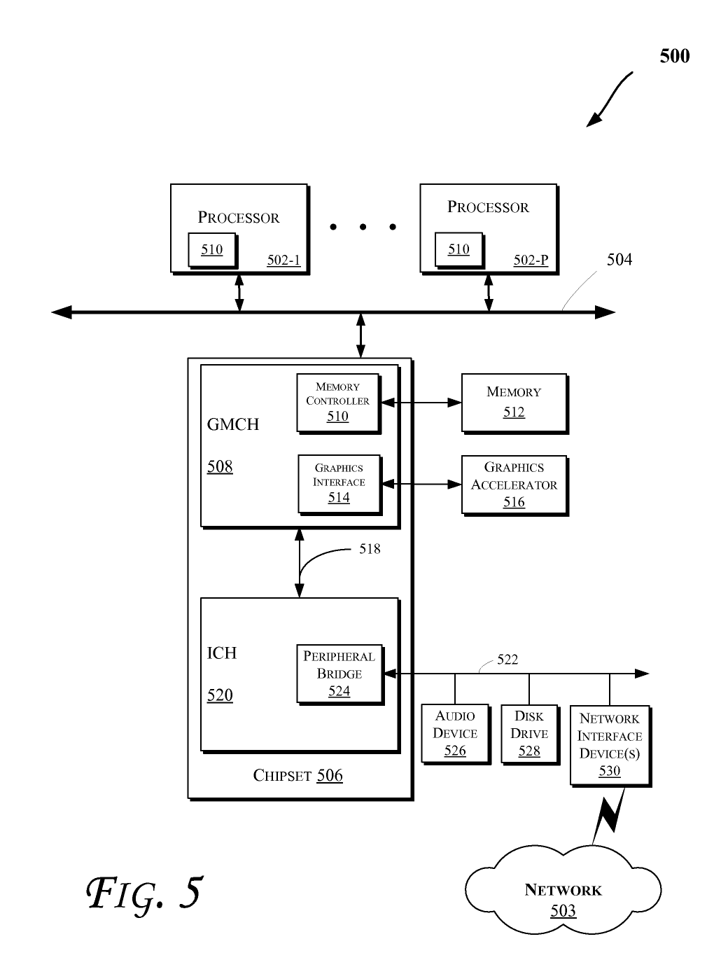

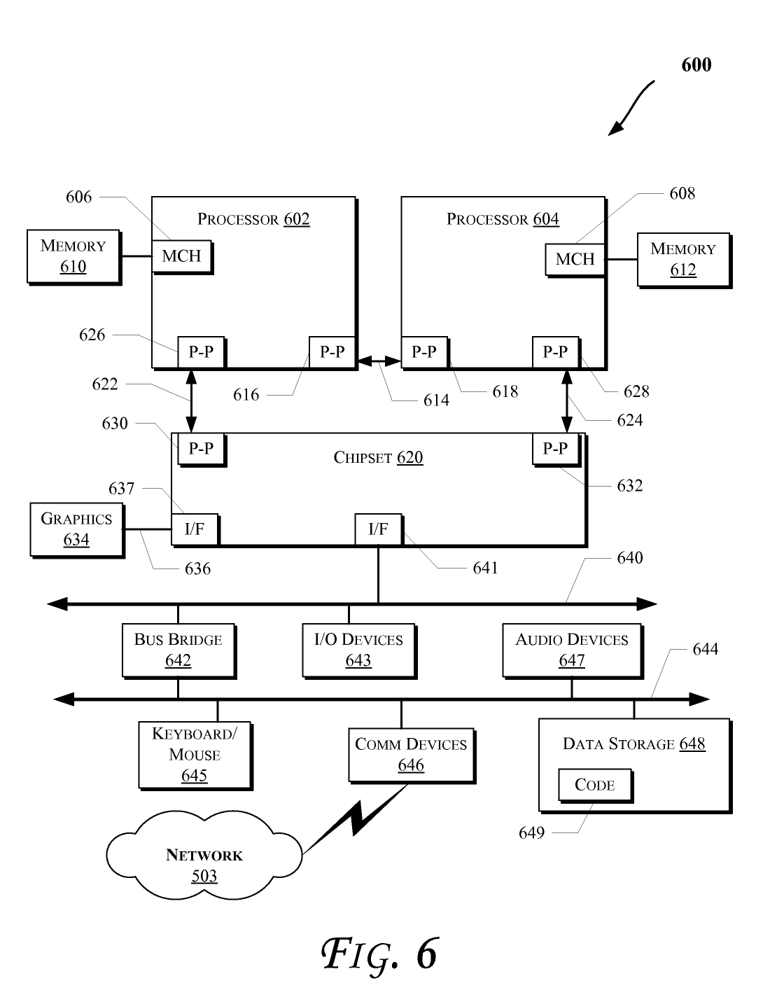

As discussed with reference to FIGS. 1-4, the signal generators and/or sensors discussed herein may be used to provide an OOB communication channel to establish secure association between devices. Such techniques may be used by various computing devices (e.g., devices 102, 104, 302, and/or 304 of FIGS. 1 and 3, respectively) which may include one or more components discussed with reference to FIGS. 5 and 6. More particularly, FIG. 5 illustrates a block diagram of a computing system 500 in accordance with an embodiment of the invention. The computing system 500 may include one or more central processing unit(s) (CPUs) or processors 502-1 through 502-P (which may be referred to herein as “processors 502” or “processor 502”). The processors 502 may communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. In an embodiment, the operations discussed with reference to FIGS. 1-4 may be performed by one or more components of the system 500. For example, logics 130, 132, 330, and/or 332 may include a processor such as processors 502.

A chipset 506 may also communicate with the interconnection network 504. The chipset 506 may include a graphics memory control hub (GMCH) 508. The GMCH 508 may include a memory controller 510 that communicates with a memory 512. The memory 512 may store data, including sequences of instructions that are executed by the processor 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The GMCH 508 may also include a graphics interface 514 that communicates with a graphics accelerator 516. In one embodiment of the invention, the graphics interface 514 may communicate with the graphics accelerator 516 via an accelerated graphics port (AGP). In an embodiment of the invention, a display (such as a flat panel display, a cathode ray tube (CRT), a projection screen, etc.) may communicate with the graphics interface 514 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 518 may allow the GMCH 508 and an input/output control hub (ICH) 520 to communicate. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the processor 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and one or more network interface device(s) 530 (which is in communication with the computer network 503). Other devices may communicate via the bus 522. Also, various components (such as the network interface device 530) may communicate with the GMCH 508 in some embodiments of the invention. In addition, the processor 502 and other components shown in FIG. 5 (including but not limited to the GMCH 508, one or more components of the GMCH 508 such as the memory controller 510, etc.) may be combined to form a single chip. Furthermore, a graphics accelerator may be included within the GMCH 508 in some embodiments of the invention.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 500 may be arranged in a point-to-point (PtP) configuration. For example, processors, memory, and/or input/output devices may be interconnected by a number of point-to-point interfaces.

FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-5 may be performed by one or more components of the system 600.

As illustrated in FIG. 6, the system 600 may include several processors, of which only two, processors 602 and 604 are shown for clarity. The processors 602 and 604 may each include a local memory controller hub (MCH) 606 and 608 to enable communication with memories 610 and 612. The memories 610 and/or 612 may store various data such as those discussed with reference to the memory 512 of FIG. 5.

In an embodiment, the processors 602 and 604 may be one of the processors 502 discussed with reference to FIG. 5. The processors 602 and 604 may exchange data via a point-to-point (PtP) interface 614 using PtP interface circuits 616 and 618, respectively. Also, the processors 602 and 604 may each exchange data with a chipset 620 via individual PtP interfaces 622 and 624 using point-to-point interface circuits 626, 628, 630, and 632. The chipset 620 may further exchange data with a graphics circuit 634 via a graphics interface 636, e.g., using a PtP interface circuit 637.

At least one embodiment of the invention utilizes the processors 602 and 604 as one or more of the logics 130, 132, 330, and/or 332 of FIGS. 3 and 3, respectively. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may communicate with a bus 640 using a PtP interface circuit 641. The bus 640 may communicate with one or more devices, such as a bus bridge 642 and I/O devices 643. Via a bus 644, the bus bridge 642 may communicate with other devices such as a keyboard/mouse 645, communication devices 646 (such as modems, network interface devices, or other communication devices that may communicate with the computer network 503), audio I/O device 647, and/or a data storage device 648. The data storage device 648 may store code 649 that may be executed by the processors 602 and/or 604.

In various embodiments of the invention, the operations discussed herein, e.g., with reference to FIGS. 1-6, may be implemented as hardware (e.g., logic circuitry), software, firmware, or any combinations thereof, which may be provided as a computer program product, e.g., including a machine-readable or computer-readable medium having stored thereon instructions (or software procedures) used to program a computer (e.g., including a processor) to perform a process discussed herein. The machine-readable medium may include a storage device such as those discussed herein.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a first device having a first sensor to detect a event and logic to generate a first set of data corresponding to the event; and
a second device having a second sensor to detect the event and logic to generate a second set of data corresponding to the event,
wherein each of the first device and the second device are to compare the first set of data and the second set of data to determine whether the first device and the second device are to be associated.

2. The apparatus of claim 1, further comprising a wireless communication channel to communicate wireless signals between the first device and the second device in response to an authentication between the first device and second device and based on the comparison of the first set of data and the second set of data.

3. The apparatus of claim 2, wherein the wireless communication channel comprises a non-secure wireless communication channel.

4. The apparatus of claim 2, wherein the wireless communication channel is to communicate one or more of: healthcare related data, entertainment related data, education related data, or telecommunication related data.

5. The apparatus of claim 1, wherein at least one of the first sensor or the second sensor comprise one or more of an analog sensor or a digital sensor.

6. The apparatus of claim 1, further comprising a communication channel to communicate analog authentication signals between the first device and the second device.

7. The apparatus of claim 1, wherein the first sensor and the second sensor comprise a same type of sensor.

8. The apparatus of claim 1, wherein at least one of the logic to generate the first set of data or the logic to generate the second set of data comprises a processor.

9. The apparatus of claim 8, wherein the processor comprises one or more processor cores.

10. The apparatus of claim 1, wherein the first device comprises a plurality of sensors.

11. The apparatus of claim 1, wherein the second device comprises a plurality of sensors.

12. The apparatus of claim 1, wherein at least one of the first sensor or the second sensor comprises one or more of: an accelerometer, an image capture device, or a microphone.

13. A method comprising:
generating a shared secret at a first device and at a second device based on an event; and
communicating authentication signals between the first device and the second device based on the shared secret,
wherein a wireless communication channel is to communicate wireless signals between the first device and the second device in response to an authentication between the first device and second device.

14. The method of claim 13, further comprising exchanging discovery information between the first device and the second device.

15. The method of claim 13, further comprising generating a session key.

16. The method of claim 15, further comprising communicating data between the first device and the second device in accordance with the session key.

17. The method of claim 15, wherein generating the session key is performed in response to the authentication.

18. A computer-readable medium comprising one or more instructions that when executed on one or more processors configure the one or more processors to:
generate a shared secret at a first device and at a second device based on an event; and
communicate authentication signals between the first device and the second device based on the shared secret,
wherein a wireless communication channel is to communicate wireless signals between the first device and the second device in response to an authentication between the first device and second device

19. The computer-readable medium of claim 18, further comprising one or more instructions that configure the one or more processors to exchange discovery information between the first device and the second device.

20. The computer-readable medium of claim 18, further comprising one or more instructions that configure the one or more processors to generate a session key.
